(19) United States
(12) Patent Application Publication
(10) Pub. No.: US 2006/0107224 A1
(43) Pub. Date: May 18, 2006

(54) Building a dynamic action for an electronic form

(75) Inventors: Ned B. Friend, Seattle, WA (US); Petru M. Moldovanu, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/988,732

(22) Filed: Nov. 15, 2004

(51) Int. Cl. G06F 9/00

(52) U.S. Cl. 715/764

(57) ABSTRACT

Systems and/or methods that enable a designer to build a dynamic action for an electronic data-entry form by selecting a triggering event and an action are described. These systems and methods may also, in one embodiment, enable a designer to build a dynamic action having a condition, which can permit tailoring of the action to a state of the electronic data-entry form or a current user of the form.

### CROSS REFERENCE TO RELATED PATENT APPLICATION

This is related to a co-pending U.S. patent application having Ser. No.______, an attorney's docket no. of MS1-2311US, and a filing date of ______ for ROLE-DEPENDENT ACTION FOR AN ELECTRONIC FORM of Friend et al. This co-pending U.S. patent application is commonly assigned herewith and is hereby incorporated herein by reference for all that it discloses.

### TECHNICAL FIELD

This invention relates to building actions for electronic forms.

### BACKGROUND

Electronic data-entry forms are commonly used to collect information. These electronic forms enable users to enter data and have that data stored digitally, such as in computer-accessible databases. Data so stored can be quickly retrieved, allowing others to use that data.

To make electronic data-entry forms more efficient and user-friendly, the forms can be built to include actions. These actions may reduce how much data a data-entry user has to enter, such as by auto-populating data-entry fields, and make data entry generally easier and less error prone.

For example, assume that an electronic data-entry form requires entry of a mailing address. To enable a user to enter this address, the form provides data-entry fields for entry of a street address, a city, a state, and a ZIP code. To enter the mailing address, the user can enter the street address, the city, the state, and the ZIP code. But a form can be more efficient and user friendly by having an action that auto-populates the city and state based on an entered ZIP code. This action enables a user to have a full address entered into the form without having to enter the city and state.

Building this and other actions into an electronic data-entry form, however, can require significant time and computer-programming skill. A person often needs to have extensive training and experience in computer programming before he or she can build actions into an electronic data-entry form. Even with extensive training, this programmer may need hours or even days to build and maintain actions for an electronic data-entry form.

Given the foregoing, there is a need in the art for an easier and/or less time-consuming way to build actions for electronic data-entry forms.

### SUMMARY

Systems and/or methods (“tools”) that enable a designer to build a dynamic action for an electronic data-entry form by selecting a triggering event and an action are described.

In one embodiment, for instance, the tools enable graphical selection of a triggering event, action, and/or condition. Responsive to these selections, the tools may then build the dynamic action for the electronic data-entry form.

In another embodiment, for instance, the tools enable a designer to build a dynamic action having a condition that depends on a role of a current user of an electronic data-entry form. By so doing, the tools enable an action to be tailored to the user that is currently using the form.

### BRIEF DESCRIPTION OF THE DRAWINGS

FIG. 1 illustrates an exemplary operating environment.

FIG. 2 illustrates an exemplary editable view of an electronic data-entry form.

FIG. 3 illustrates an exemplary rule dialog.

FIG. 4 illustrates an exemplary action dialog.

FIG. 5 illustrates an exemplary action parameter dialog.

FIG. 6 illustrates an exemplary data-source selector and a hierarchical representation of an electronic data-entry form.

FIG. 7 illustrates a modified view of the action parameter dialog of FIG. 5.

FIG. 8 illustrates an exemplary insert formula dialog.

FIG. 9 illustrates an exemplary completed action field of an updated version of the rule dialog of FIG. 3.

FIG. 10 illustrates an exemplary runtime view of an electronic data-entry form.

FIG. 11 is a flow diagram of an exemplary process for building a dynamic action for an electronic data-entry form.

FIG. 12 is a flow diagram of an exemplary process for executing a dynamic action for an electronic data-entry form.

The same numbers are used throughout the disclosure and figures to reference like components and features.

### DETAILED DESCRIPTION

Overview

The following disclosure describes a user-friendly way to build dynamic actions for electronic data-entry forms. A person designing a form, for instance, is able to build a dynamic action into an electronic data-entry form without having to understand a computer language, have computer-program training, or write script or code.

In one embodiment, a designer is able to build a dynamic action for an electronic data-entry form through a graphical user interface. This dynamic action can comprise declarative business logic capable of targeting arbitrary data structures in response to user-driven events. These arbitrary data structures can comprise data-entry fields of an electronic data-entry form; and the user-driven events can comprise triggering events of the electronic data-entry form, such as a user loading the form or changing data in the form.

In another embodiment, a designer is able to build a dynamic action having a condition. This condition may be used to make an action dependent on a state of an electronic data-entry form, data from secondary sources, or a role of a current user of the form. When dependent on a current user's role, an action may be tailored to fit that user's role.

Exemplary Operating Environment

Before describing the tools for building actions in detail, the following discussion of an exemplary operating environment is provided to assist the reader in understanding where and how the tools may be employed. It is to be understood that the description provided below constitutes but one example and is not intended to limit application of the tools to any one particular operating environment.

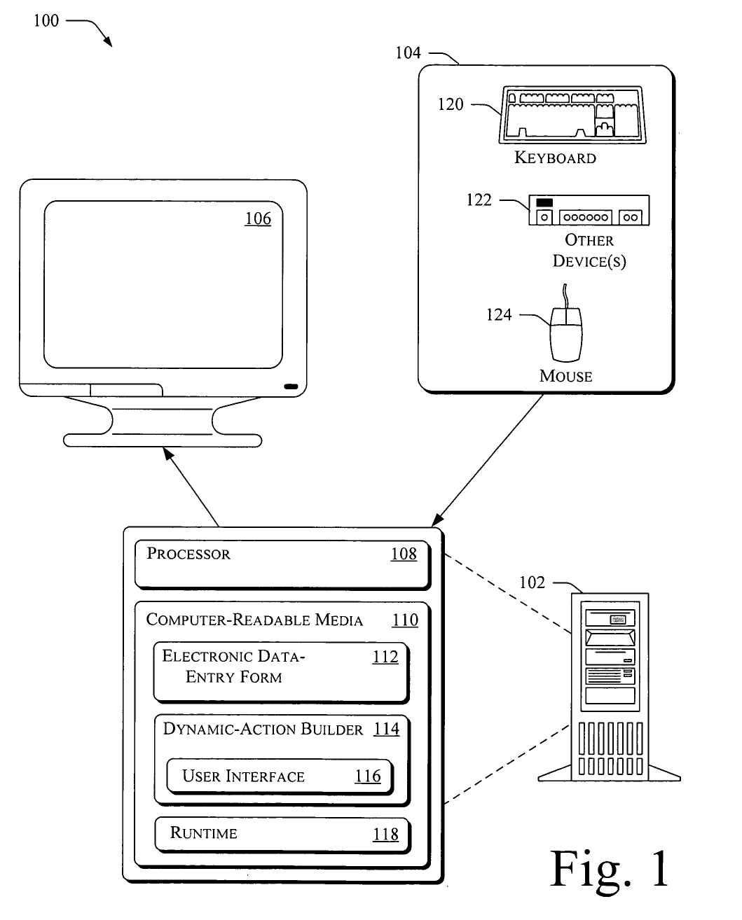

FIG. 1 illustrates one such operating environment generally at 100 comprising a computer 102, user-input devices 104, and a display 106. The computer is shown comprising a processor 108 and computer-readable media 110. The processor is capable of accessing and/or executing the computer-readable media. The computer-readable media comprises an electronic data-entry form 112, a dynamic-action builder application 114 having a user interface 116, and a runtime application 118.

The dynamic-action builder is capable of enabling a designer to build an action for the electronic data-entry form. The user interface is capable of presenting and receiving information to and from the designer, such as through the display and the user-input devices. The user-input devices may comprise any device allowing a computer to receive the designer's preferences, such as a keyboard 120, other device(s) 122, and a mouse 124. The other input devices may comprise, for example, a touch screen, a voice-activated input device, and a track ball.

The runtime application is capable of executing a dynamic action for an electronic data-entry form and enabling a user to interact with the electronic data-entry form.

Dynamic Actions

The following discussion describes dynamic actions, after which ways in which the tools enable a designer to build dynamic actions are described.

In accordance with one embodiment, a dynamic action can have two or more parts. One part is the action itself. Actions can provide automated functionality for an electronic data-entry form, such as auto-populating data into a data-entry field, enabling selection of a particular field or selector, and presenting a dialog.

Another part of a dynamic action is a triggering event. Triggering events are associated with or generated by an electronic data-entry form and may be caused by a user's interaction with the electronic data-entry form.

Triggering events may be associated generally with an electronic data-entry form or specifically with a particular part of an electronic data-entry form. Opening an electronic data-entry form or submitting an entire electronic data-entry form, for instance, can comprise a triggering event associated generally with the form. Changing data in a data-entry field or selecting some part (e.g., a button) of an electronic data-entry form, for instance, can comprise a triggering event associated with a particular part of the form.

A dynamic action may also comprise a condition. A condition contains information about the state of the form, secondary data, or a user of the form, such as whether or not data in one data-entry field is larger than data in another data-entry field, whether or not data from a web server is of a particular type, or whether or not the user of the form has certain rights.

Building Dynamic Actions

The following discussion describes ways in which the tools enable a designer to build a dynamic action for an electronic data-entry form.

To facilitate building a dynamic action, the tools may enable a designer to graphically select a triggering event. The tools can do so through a graphical user interface presenting, for example, the following triggering events: a data change trigger, caused by a user modifying data in the electronic data-entry form; a click trigger, caused by a user clicking on a selector (e.g., a button); a load trigger, caused when a user opens the form; and a submit trigger, caused with the user submits the form.

For triggering events associated with a particular part (e.g., a data structure) of the electronic data-entry form, selection of the particular part may be enabled through graphical presentation of various views of the electronic data-entry form, such as views having areas in which selectable data-entry fields or nodes are presented.

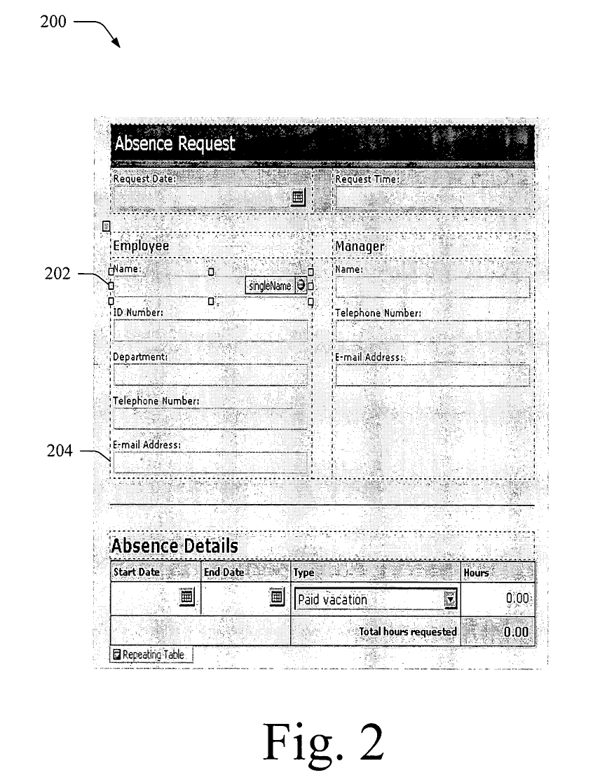

In the illustrated embodiment starting with FIG. 2, dynamic-action builder 114 enables graphical selection of a triggering event through presentation of an exemplary electronic data-entry form area having an editable view 200 of the electronic data-entry form 112. The dynamic-action builder can do so through user interface 116 and with point-and-click selection via mouse 124, for instance. This view is shown with a name data-entry field 202 having been selected. The dynamic-action builder may assume, because the selected name field is capable of enabling a user to change data in the electronic data-entry form, that the triggering event desired is the data change trigger.

Also as part of the enabled graphical selection, the designer is able to graphically select an arbitrary data structure for the triggering event. Here the designer selects the name field, which has a corresponding node in the form's data structure. In this embodiment, the form is represented in a hierarchically structured electronic document written in part using a markup language, such as eXtensible Markup Language (XML).

When a designer selects a particular data-entry field, rather than the entire electronic data-entry form, the dynamic-action builder makes the dynamic action dependent on a triggering event caused by a user's action related to the selected field. In this case, the dynamic-action builder builds the dynamic action such that it is triggered when a user of the electronic data-entry form changes (adds, deletes, or modifies) data in the name field.

In the illustrated embodiment, a portion of the dynamic action is logically structured as a “rule” associated with the dynamic action's triggering event. This rule executes when triggered by the dynamic action's triggering event and may comprise a condition and one or more actions. The condition, if one is present, is evaluated to determine whether or not to perform the action or actions. If no condition is present, the action(s) can be performed.

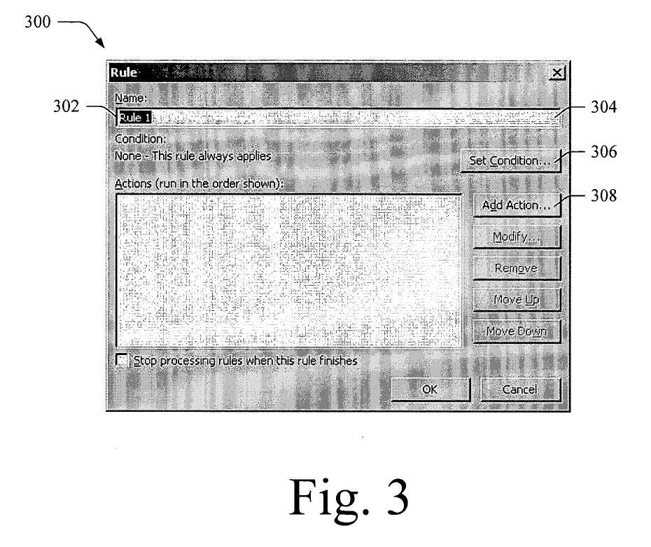

Referring to FIG. 3, the dynamic-action builder enables a designer to view his or her progress in building the dynamic action in a dynamic action area and to continue to build the dynamic action by selecting to add or modify a condition or action through this area, here shown with an exemplary rule dialog 300. The rule dialog presents a default title 302 (“Rule 1”) for a rule associated with the triggering event for name field 202. The rule dialog enables the designer to select another name for the rule (through name field 304), set a condition (through condition button 306), and add or modify one or more actions (through action button 308).

A condition may be added if a designer wishes to make actions conditional. It can be evaluated when the electronic data-entry form is being run (and thus when a user can be interacting with it) and determines whether the action(s) of the rule are executed.

In one embodiment, a condition is stored as an XML path language (XPath) expression that returns a Boolean value. Thus, if it returns “false” the action or actions of the rule are not performed. XPath expressions buildable by the dynamic-action builder can evaluate data structures (such as nodes of an electronic data-entry form), a string, and the like.

In the illustrated and described embodiment, conditions, whether comprising an XPath expression or otherwise, may comprise: values in an electronic data-entry form; comparison and equality operators for comparing and equating values; constant values, like numbers and strings; calculated values, like those from performance of mathematical functions; pattern matching; a user's current role, rights, and/or identity; and whether the form or part of it is digitally signed.

These conditions can be built to depend on information about a user, such as by finding and analyzing a role or identity of a current user of the electronic data-entry form. Based on this information, a condition may return a Boolean value causing an action to be performed or not performed. An example of this is set forth below in a section entitled “Role-Based Conditions” .

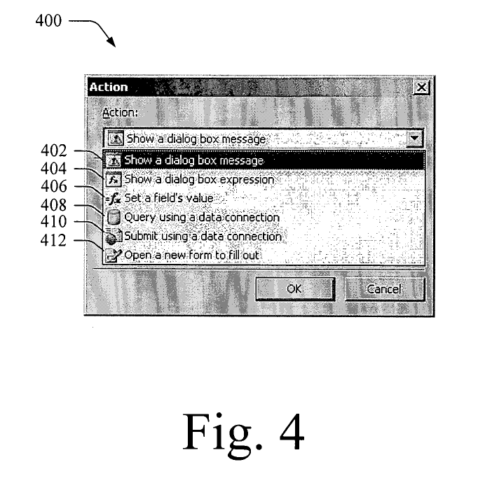

Continuing the illustrated embodiment, the designer selects action button 308 of FIG. 3. Responsive to this selection, the dynamic-action builder enables selection of various actions though an action selection area, an example of which is shown with an exemplary action dialog 400 of FIG. 4. The action dialog enables graphical selection of an action for an electronic data-entry form. The action shown as highlighted in the action dialog is dialog box action 402, which can show a dialog box message when the action is performed.

Selectable actions shown in the action dialog comprise: the dialog box action; a dialog box expression action 404; a set a field's value action 406; a query action 408; a submit action 410; and an open a new form action 412.

The dynamic-action builder may enable selection of parameters through a parameter area. It may do so responsive to selection of an action, such as one of these actions 404 through 412. These parameters may be set to govern how an action is to be performed.

The dynamic-action builder may enable, such as through selection of these actions and their parameters, a designer to add actions to an electronic data-entry form that perform the following: present a dialog box to a user having static (e.g., set now) or dynamic (set based on future or internal-to-the-form information) text; switch a current view shown; assign a calculated value to a data-entry field of the form; submit data using a pre-defined data connection; query data using a pre-defined data connection; open a new form, such as from a specified form template; close the current form; enable a digital signature (e.g., based on a role of a current user); and enable selection of a workflow function (e.g., based on a role of a current user). In one embodiment, many of these actions comprise methods, functions, and formulas equivalent to a set of object model calls in a programming language.

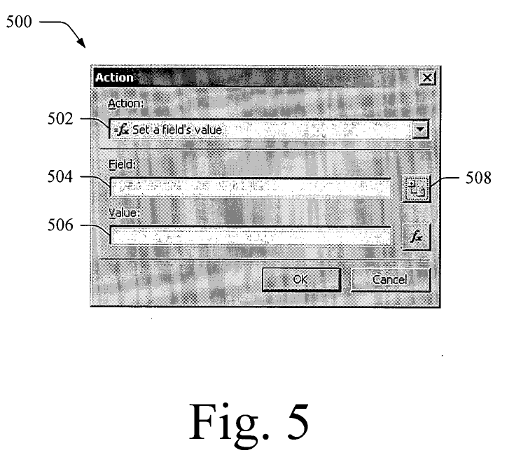

Continuing the illustrated embodiment, the designer selects the action for setting a field's value (406) of FIG. 4. Responsive to this selection, the dynamic-action builder enables selection of parameters for this action though an exemplary action parameter dialog 500 shown in FIG. 5. This action, as well as some of the other actions, is capable of altering or modifying an arbitrary data structure of electronic data-entry form 112 (e.g., a data-entry field or node). The action chosen is shown in field 502, and selection of two parameters for this action is enabled: a field to be modified through “field” field 504; and a value through “value” field 506.

The dynamic-action builder enables the designer to select a data-entry field of the electronic data-entry form on or about which to perform an action. In this embodiment, the designer is enabled to select which field is to have its value set. The designer can select this field by typing in a expression capable of identifying that field in field 504 or graphically. The user interface can enable the designer to select a data-entry field through the design view 200 of the electronic data-entry form shown in FIG. 2, or through a data source representation of electronic data-entry form.

In the illustrated embodiment, the dynamic-action builder enables the designer to select the field by clicking on a data source selection button 508, after which the dynamic-action builder presents a data source representation of electronic data-entry form 112.

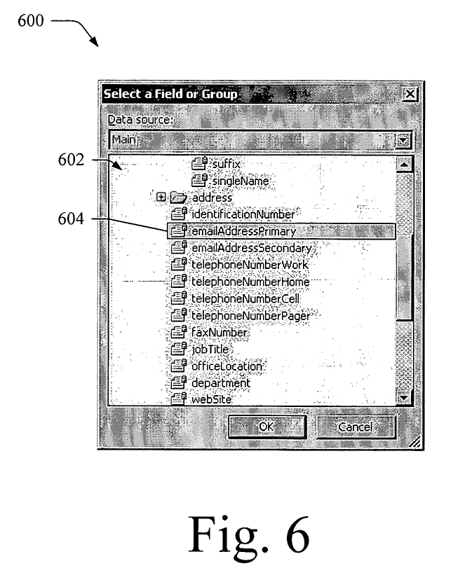

FIG. 6 sets forth an exemplary data-source selector 600 showing a hierarchical representation 602 of the electronic data-entry form. Through this representation, the designer can select the field. Here the designer is shown to have selected the emailAddressPrimary node 604, which corresponds to E-mail address data-entry field 204 shown in FIG. 2.

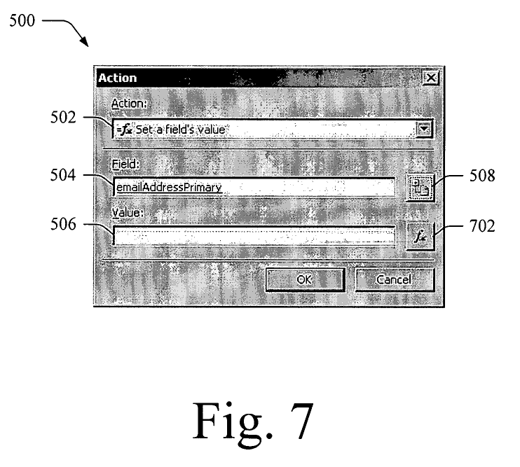

Responsive to this selection, the dynamic-action builder fills the name of the selected field into a modified view of action parameter dialog 500, here shown in FIG. 7.

The dynamic-action builder enables the designer to select the value for the E-Mail Address field 204. The designer is able to enter a fixed value to automatically populate into the E-Mail Address field 204 when the trigging event happens (here when a user changes data in name field 202). In this case, however, the designer select a function button 702 to have the value set for the E-Mail Address field 204 to be set based on a calculation and/or during runtime of the electronic data-entry form.

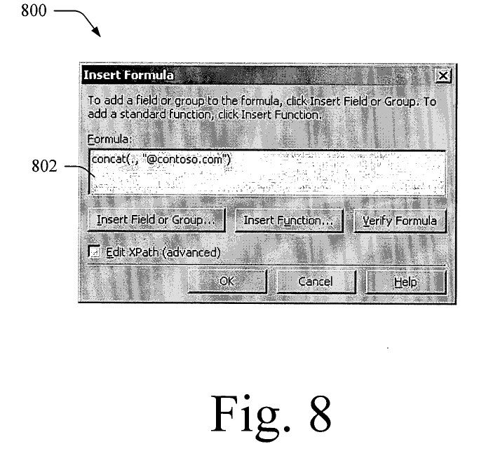

The dynamic-action builder enables the designer to set this function. In the illustrated embodiment, the dynamic-action builder presents an insert formula dialog 800, shown in FIG. 8. To insert a formula, the designer can select from a pre-set list of formulas (not shown), like a summing function or a concatenation function and many others. In the illustrated embodiment, the designer selected a concatenation function, which the dynamic-action builder presented as “concat(.,””). This is one manner in which the dynamic-action builder can build functions; some functions are presented needing only a designer to graphically select the function and field(s)/node(s) on which it acts. In this case, the function is presented assuming that the data of the associated data-entry field (here text of the name field) will be concatenated with (combined as a string with) text that the designer can enter between the double quotes. An explanation of how this function can be built may also be provided for the designer.

In the illustrated embodiment, the designer enters “@contoso.com” between the quotation marks. By so doing, the dynamic action built can perform an action that builds an email address based on a name entered into the name field 202. This will be illustrated below.

The dynamic-action builder can present the action parameters fully completed, such as by adding the contents of formula field 802 into value field 506 of FIGS. 5 and 7 (not shown). The dynamic-action builder can also present a dialog showing the triggering event and the rule for the dynamic action once the dynamic action is complete.

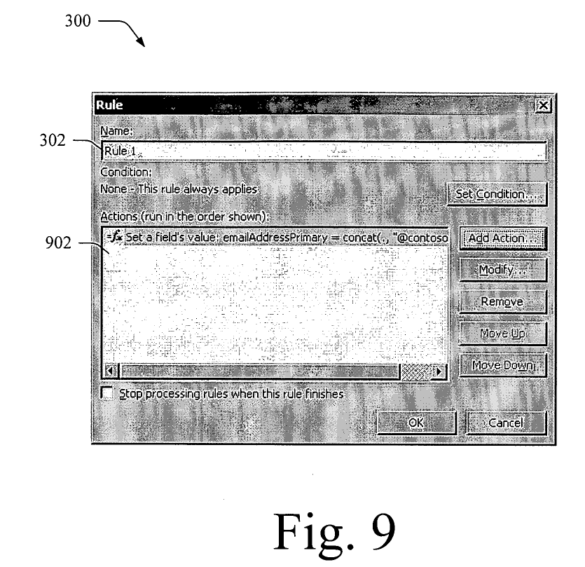

In the illustrated embodiment, the dynamic-action builder updates the rule dialog 300 of FIG. 3 to show the action now selected for the rule. FIG. 9 sets forth this action in a completed action field 902 of an updated version of the rule dialog 300. Following this, the designer can add actions or modify the current actions (not shown).

This is but one example of the dynamic-action builder enabling a designer to create a dynamic action for an electronic data-entry form. In this example, the dynamic-action builder creates a declarative syntax for the dynamic action using XML. Thus, the dynamic-action builder generates the following declarative syntax for the above-built dynamic action:

<xsf:domEventHandler

match=“/ar:absenceRequest/ar:contact/ar:name/ar:singleName”>

<xsf:ruleSetAction ruleSet=“ruleSet_1”></xsf:ruleSetAction>

</xsf:domEventHandler>
<xsf:ruleSets>

<xsf:ruleSet name=“ruleSet_1”>

<xsf:rule caption=“Rule 1”>

<xsf:assignmentAction

targetField=“../../ar:emailAddressPrimary”expression=“concat(.,&quot;@contoso.com&quot;)”></x
sf:assignmentAction>

</xsf:rule>

</xsf:ruleSet>

</xsf:ruleSets>

The first four lines above represent the declarative syntax for the triggering event of the dynamic action. This triggering event can apply to multiple rules. The remaining lines represent the declarative syntax for the rule. In this case, the rule comprises the selected set field value action that concatenates “@contoso.com” after the text entered into name field 202 and enters this into the E-Mail Address field 204. This declarative syntax can be stored in or associated with the electronic data-entry form. At runtime it can be converted into executable code, such as into runtime objects internal to the electronic data-entry form.

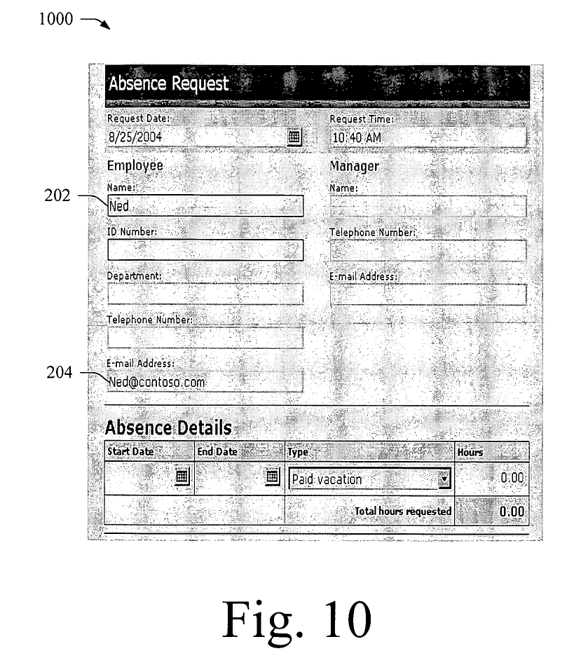

Continuing the illustrated embodiment, at runtime a user enters data into name data-entry field 202 of electronic data-entry form 112. FIG. 10 sets forth a runtime view 1000 of the form, with the name data-entry field shown with “Ned” entered. Once data of this field is changed, the triggering event of the dynamic action occurs. Then, executable code for the rule is run. With no condition, the action (to set the value for E-mail Address field 204) is performed. This action, as described above, auto-populates the E-mail Address field with a concatenation of the data entered into the name field with “@contoso.com” . Thus, “Ned” is combined in a string with “@contoso.com”, which is shown as “Ned@contoso.com”.

Role-Based Conditions

As mentioned in part above, the tools enable building of dynamic actions with one or more conditions. These conditions can be built to depend on a state of the electronic data-entry form, secondary data (e.g., data from a secondary source like a remote server), or a user of the form. The following discussion focuses on a condition dependent on a user's role. Like other conditions, a condition based on a user's role (e.g., identity or rights) may return a Boolean causing an action to be performed or not performed.

A user's role may comprise information about the user that is capable of affecting some action for the electronic data-entry form. Based on the role of a person currently using the electronic data-entry form, an action or actions may or may not be performed.

Assume, for instance, that four roles are established for potential users of an electronic data-entry form. The first role is a salesman, the second a sales manager, the third a warehouse manager, and the fourth a vice president. If a dynamic action has a load trigger, for instance, the dynamic action's rule may be executed when a user loads the electronic data-entry form. When executed, the rule executes the condition. If the condition is based on the role of the user that opened the electronic data-entry form, an action or actions can be executed based on the user's role. Thus, if one action enables approval buttons and the condition returns a “true” Boolean for the sales manager, the warehouse manager, and the vice president but a “false” Boolean for the salesman, the electronic data-entry form presents an approval button for the managers and vice president but not for the salesman.

Performing (or not performing) actions based on a user's role has many applications. A dialog box directed to a particular individual may be presented when that particular individual opens an electronic data-entry form, changes data in a field, or makes a selection in the form. A digital signature enabled for a particular person or role (like being a manager) may be enabled for a particular person or role but not others. Overriding a built-in constraint, like automatically overriding rejection of an expense report when too much money is entered, may be enabled based on which user opened the form. Conditional actions may also alter how and what an electronic data-entry form presents based on who is viewing the electronic data-entry form. A user that has poor vision for instance, may have a role identifying this disability. An action increasing the font size of the electronic data-entry form may be performed conditional on a user having this disability.

Similarly, actions responsive to which person is viewing an electronic data-entry form may enable client-side workflow. Continuing one example above, if the salesman submits an electronic data-entry form for a purchase order, the sales manager can open that order form and be presented an option to approve the purchase order. Similarly, the vice president can open the same order form and be presented a dialog showing that the salesman is waiting for approval but that the sales manager has not yet approved, for example.

In one embodiment, client-side workflow is enabled without need of a remote data source, like a computer server on the Internet. Continuing the above example, if the salesman, the sales manager, and the vice president each have software capable of running the electronic data-entry form and its dynamic actions and can access the electronic data-entry form (such as by receiving it via email), each is enabled to perform workflow functions on the electronic data-entry form. Similarly, if the salesman, the sales manager, and the vice president each have access to a local data source, like a computer server on a company intranet, each may be enabled to perform workflow functions. Thus, these workflow functions may be tailored for each of the salesman, sales manager, and vice president based on his or her role.

Cascading Condition

In one embodiment, the tools enable dynamic actions with a cascading condition to be built for an electronic data-entry form.

For example, if one dynamic action has a triggering event of an expense data-entry field being changed but is conditional on that expense field having too large a number (without that condition being dependent on some other condition), it may be performed based on one, non-cascading condition. In this case, the action may switch the view if the number in the field is too high, the switched view reading: “your expense number is too high and must be approved by your manager”, and having two selectable buttons, one saying “submit for approval” and the other “lower expense to maximum allowed”. If the user selects the “lower expense to maximum allowed” another action can set the value of that field (similarly to the example above).

A second dynamic action can rely on a cascading condition by depending on this first dynamic action through its own condition. Assume for example that the second dynamic action is triggered by the user selecting the “submit for approval” button but is conditional on a role-based condition and that its action can present a dialog. This dynamic action may present, if the user is not a manager, a dialog saying “approval requested from manager”. It may also request approval of the manager, either actively or by recording that the approval is requested, so that when the manager opens the form the manager may approve or deny the approval request. But this dynamic action can also present a dialog saying “approved” if the current user is a manager. Thus, this second dynamic action has cascading dependencies by depending on the condition of the first dynamic action through its own condition. Through cascading dependencies like this, the tools enable extensive and complex functionality to be added to an electronic data-entry form through dynamic actions.

Process for Building Dynamic Actions

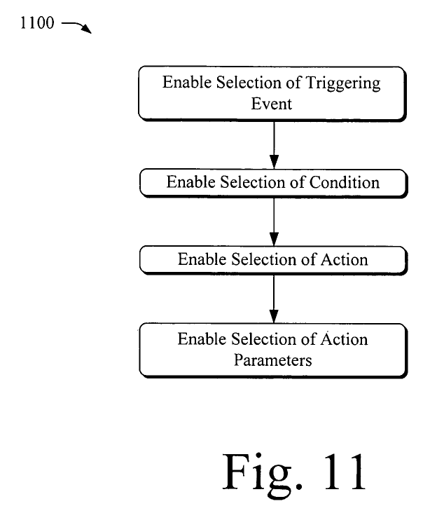

FIG. 11 shows a flow diagram for an exemplary process 1100 for building a dynamic action for an electronic data-entry form. Process 1100 is illustrated as a series of blocks representing individual operations or acts performed by elements of the operating environment 100 of FIG. 1, such as the dynamic-action builder 114 and its user interface 116. This and other processing disclosed herein may be implemented in any suitable hardware, software, firmware, or combination thereof, in the case of software and firmware, these processes represent a set of operations implemented as computer-executable instructions stored in computer-readable media 110 and executable by processor 108.

At block 1102, dynamic-action builder 114 enables selection of a triggering event. The dynamic-action builder can enable this selection through a graphical user interface, such as is described in the above examples. As part of this block, the dynamic-action builder enables selection of arbitrary data structures of an electronic data-entry form for triggering events associated with data structures of the electronic data-entry form. This selection may be enabled through graphical selection of the data structure, such as through selection of a data-entry field and/or node corresponding to the data structure. Examples of this are set forth above.

At block 1104, the dynamic-action builder enables selection of a condition. The dynamic-action builder can do so using a graphical user interface, such as set forth in the above-described examples. Types of selectable conditions are also described above.

At block 1106, the dynamic-action builder enables selection of an action. This selection can be through a graphical user interface, such as set forth in the above described example. Actions selected can be added, modified, or deleted. Multiple actions can be selected for each condition and/or triggering event.

At block 1108, the dynamic-action builder enables selection of parameters for the selected action. Parameters for each action may differ. For this reason, the dynamic-action builder can enable selection of parameters associated with the selected action. Selection of parameters may be through a graphical user interface or otherwise, such as set forth above.

The dynamic-action builder may enable creation of additional actions for a selected triggering event, such as by performing blocks 1104, 1106, and/or 1108 one or more additional times.

Executing Dynamic Actions

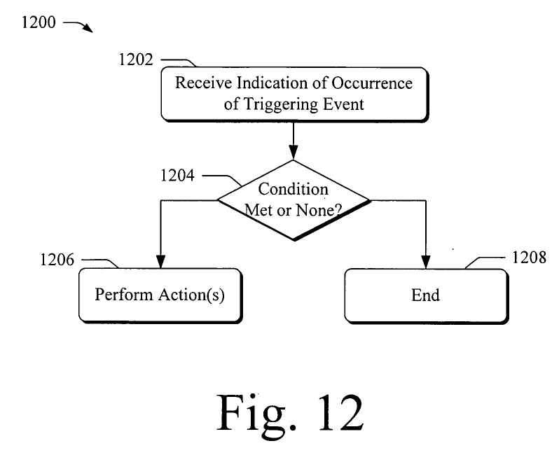

FIG. 12 shows a flow diagram for an exemplary process 1200 for executing a dynamic action for an electronic data-entry form. Process 1200 is illustrated as a series of blocks representing individual operations or acts performed by elements of the operating environment 100 of FIG. 1, such as runtime 118.

At block 1202, the runtime receives an indication that a triggering event has occurred. The triggering event can be caused by a user's interaction with an electronic data-entry form, such as those described above.

At block 1204, the runtime determines whether or not a condition is met or that none exists for a dynamic action triggered by the triggering event. In one embodiment, this is performed by executing a rule that may or may not have a condition. As set forth above, a condition may return a Boolean indicating whether or not the condition is met. If no condition exists or the condition is met, the runtime proceeds along a “Yes” path to block 1206. If a condition exists and is not met, the runtime proceeds along a “No” path to block 1208.

At block 1206 the runtime executes the action (or actions) responsive to occurrence of the triggering event. Examples of actions are set forth above.

At block 1208 the runtime does not execute the action(s) that depends on the unmet condition.

Following performance of blocks 1206 and/or 1208, additional actions (again with or without conditions) may be executed responsive to occurrence of the triggering event of block 1202. In this case, blocks 1204, 1206, and/or 1208 may be repeated for other actions.

Conclusion

The above-described systems and methods enable a designer to build a dynamic action for an electronic data-entry form by selecting a triggering event and an action. These systems and methods may also enable a designer to build a dynamic action having a condition, which permits tailoring of the action to a state of the electronic data-entry form, secondary data, or a current user of the form. Although the system and method has been described in language specific to structural features and/or methodological acts, it is to be understood that the system and method defined in the appended claims is not necessarily limited to the specific features or acts described. Rather, the specific features and acts are disclosed as exemplary forms of implementing the claimed system and method.

1. A method comprising:
enabling selection of a triggering event of an electronic data-entry form;
enabling selection of an action; and
building, responsive to the selections, a dynamic action for the electronic data-entry form that is capable of performing the selected action dynamically in response to occurrence of the triggering event, wherein at least one of the acts of enabling is performed through graphical selection.

2. The method of claim 1, wherein at least one of the acts of enabling selection of the triggering event and at least one of the acts of enabling selection of the action are performed through graphical selection.

3. The method of claim 1, wherein the act of enabling selection of the triggering event comprises enabling point-and-click graphical selection of the triggering event.

4. The method of claim 1, wherein the act of enabling selection of the triggering event comprises enabling selection of an event caused by a user's modification of data in the electronic data-entry form.

5. The method of claim 1, wherein the act of enabling selection of the triggering event comprises enabling selection of an event caused by a user's selection of a non-text-entry input of the electronic data-entry form.

6. The method of claim 1, wherein the act of enabling selection of the triggering event comprises enabling selection of an event caused by a user's opening of the electronic data-entry form.

7. The method of claim 1, wherein the act of enabling selection of the triggering event comprises enabling selection of an event caused by a user's submission of the electronic data-entry form.

8. The method of claim 1, wherein the act of enabling selection of the triggering event comprises enabling graphical selection of an arbitrary data structure of the electronic data-entry form to which the triggering event is to be associated.

9. The method of claim 8, wherein the act of enabling graphical selection of the arbitrary data structure comprises presenting the electronic data-entry form having a selectable data-entry field representing the arbitrary data structure.

10. The method of claim 8, wherein the act of enabling graphical selection of the arbitrary data structure comprises presenting a hierarchical representation of the electronic data-entry form having a selectable node representing the arbitrary data structure.

11. The method of claim 1, further comprising enabling selection of a condition, and wherein the act of building comprises building the dynamic action having the selected condition, the condition capable of disabling performance of the selected action.

12. The method of claim 11, wherein the act of enabling selection of the condition comprises enabling graphical selection of an arbitrary data structure of the electronic data-entry form to which the condition is to be associated.

13. The method of claim 1, wherein the act of enabling selection of the action comprises enabling point-and-click graphical selection of the action.

14. The method of claim 13, further comprising enabling selection of parameters for the selected action.

15. The method of claim 1, wherein the act of enabling selection of the action comprises enabling selection of one or more actions comprising a method or function equivalent to an object-model call in a programming language.

16. The method of claim 1, wherein the act of building comprises building the dynamic action comprising a declarative syntax capable of targeting an arbitrary data structure of the electronic data-entry form.

17. The method of claim 16, wherein the declarative syntax comprises an eXtensible Markup Language.

18. One or more computer-readable media having computer-readable instructions for performing the method recited in claim 1.

19. A system comprising means for performing the method recited in claim 1.

20. A graphical user interface capable of performing the method recited in claim 1.

21. A method comprising:
enabling selection of a triggering event associated with an arbitrary data structure of an electronic data-entry form;
enabling selection of an action to be performed responsive to occurrence of the triggering event;
enabling selection of a condition capable of disabling performance of the selected action; and building a dynamic action comprising the triggering event, the action, and the condition, wherein the dynamic action is capable of performing the action responsive to occurrence of the triggering event and dependent on the condition.

22. The method of claim 21, wherein at least one of the acts of: enabling selection of the triggering event; enabling selection of the action; and enabling selection of the condition is through graphical selection.

23. The method of claim 21, wherein the act of enabling selection of the triggering event comprises enabling selection of a user-driven event of the electronic data-entry form.

24. The method of claim 21, wherein the act of enabling selection of the triggering event comprises enabling graphical selection of the arbitrary data structure of the electronic data-entry form with a selectable data-entry field representing the arbitrary data structure.

25. The method of claim 21, wherein the act of enabling selection of the triggering event comprises enabling graphical selection of a node representing the arbitrary data structure.

26. The method of claim 21, wherein the act of enabling selection of the condition comprises enabling selection of a condition dependent on a second dynamic action of the electronic data-entry form.

27. The method of claim 21, wherein the electronic data-entry form comprises extensible Markup Language (XML) and the condition comprises an XML path language expression.

28. The method of claim 21, wherein the condition is capable of comprising information about a state of the electronic data-entry form.

29. The method of claim 21, wherein the condition is capable of comprising information about data accessible from a secondary source.

30. The method of claim 21, wherein the condition is capable of comprising information about a then-current user of the electronic data-entry form.

31. The method of claim 21, further comprising enabling graphical selection of parameters for the selected action.

32. The method of claim 21, wherein the act of enabling selection of the action comprises enabling selection of one or more actions comprising a method or function equivalent to an object-model call in a programming language.

33. The method of claim 21, wherein the act of building comprises building the dynamic action comprising a declarative syntax.

34. The method of claim 33, wherein the declarative syntax comprises an eXtensible Markup Language.

35. One or more computer-readable media having computer-readable instructions for performing the method recited in claim 21.

36. A graphical user interface capable of performing the method recited in claim 21.

37. A system comprising means for performing the method recited in claim 21.

38. One or more computer-readable media having computer-readable instructions therein that, when executed by a computer, cause the computer to perform acts comprising:
receiving an indication of an occurrence of a user-driven event associated with an arbitrary data structure of an electronic data-entry form; and
responsive to the receiving, performing an action for the electronic data-entry form.

39. The media of claim 38, wherein the arbitrary data structure comprises a data-entry field of the electronic data-entry form.

40. The media of claim 38, wherein the user-driven event comprises loading the electronic data-entry form.

41. The media of claim 38, wherein the user-driven event comprises submitting the electronic data-entry form.

42. The media of claim 38, wherein the user-driven event comprises changing data of the arbitrary data structure.

43. The media of claim 42, wherein the change comprises adding, modifying, or deleting data of a data-entry field of the electronic data-entry form.

44. The media of claim 38, wherein the user-driven event comprises clicking on a button.

45. The media of claim 38, wherein the act of performing the action comprises performing the action on a second arbitrary data structure of the electronic data-entry form.

46. The media of claim 38, wherein the computer-readable media comprises extensible Markup Language (XML).

47. A system embodying the computer-readable media of claim 38.

48. One or more computer-readable media having computer-readable instructions therein that, when executed by a computer, cause the computer to perform acts comprising:
receiving an indication of performance of a first action, the first action performed responsive to occurrence of a triggering event of an electronic data-entry form and dependent on a first condition being met; and
performing a second action responsive to performance of the first action, the second action dependent on a second condition being met by performance of the first action.

49. A system embodying the computer-readable media of claim 48.

50. A graphical user interface comprising:
a first area to display selectable data structures of an electronic data-entry form;
a second area to display selectable actions performable at occurrence of a triggering event associated with a selected data structure; and
a third area to display selectable parameters governing how a selected action is to be performed.

51. The graphical user interface of claim 50, further comprising a fourth area to display selectable conditions on which performance of the selected action depends.

52. The graphical user interface of claim 50, wherein the first area comprises an electronic data-entry form area, the second area comprises an action selection area, and the third area comprises a parameter area.

53. The graphical user interface of claim 50, further comprising a fourth area to display the triggering event.
